(19) United States
(12) Patent Application Publication
(10) Pub. No.: US 2024/0347871 A1
(43) Pub. Date: Oct. 17, 2024

(54) COCKTAIL MODULE DESIGN FOR TUNABLE FUNCTIONS

(71) Applicant: GM GLOBAL TECHNOLOGY OPERATIONS LLC, Detroit, MI (US)

(72) Inventors: Jingyuan Liu, Shannghai (CN); Dewen Kong, Shanghai (CN); Zhe Li, Shanghai (CN); Haijing Liu, Shanghai (CN); Dave G. Rich, Sterling Heights, MI (US)

(21) Appl. No.: 18/361,962

(22) Filed: Jul. 31, 2023

(30) Foreign Application Priority Data
Apr. 11, 2023 (CN) 202310388972.1

(51) Int. Cl. H01M 50/51; H01M 10/0525; H01M 10/30; H01M 10/48

(52) U.S. Cl. CPC H01M 50/51; H01M 10/0525; H01M 10/30; H01M 10/482; H01M 2220/20

(57) ABSTRACT

A battery includes: a positive output terminal; a negative output terminal; a first battery module that is connected to the positive output terminal and the negative output terminal and that includes: a first string of first and second types of battery cells that are electrically connected in series, where the first type is different than the second type; and a second battery module that is electrically connected in parallel with the first battery module and that includes: a second string of the first and second types of battery cells that are electrically connected in series.

### CROSS-REFERENCE TO RELATED APPLICATIONS

This application claims the benefit of Chinese Patent Application No. 202310388972.1, filed on Apr. 11, 2023. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to batteries and more particularly to battery systems and methods with battery modules having multiple different types of battery cells.

Some types of vehicles include only an internal combustion engine that generates propulsion torque. Hybrid vehicles include both an internal combustion engine and one or more electric motors. Some types of hybrid vehicles utilize the electric motor and the internal combustion engine in an effort to achieve greater fuel efficiency than if only the internal combustion engine was used. Some types of hybrid vehicles utilize the electric motor and the internal combustion engine to achieve greater torque output than the internal combustion could achieve by itself.

Some example types of hybrid vehicles include parallel hybrid vehicles, series hybrid vehicles, and other types of hybrid vehicles. In a parallel hybrid vehicle, the electric motor works in parallel with the engine to combine power and range advantages of the engine with efficiency and regenerative braking advantages of electric motors. In a series hybrid vehicle, the engine drives a generator to produce electricity for the electric motor, and the electric motor drives a transmission. This allows the electric motor to assume some of the power responsibilities of the engine, which may permit the use of a smaller and possibly more efficient engine. The present application is applicable to electric vehicles, hybrid vehicles, and other types of vehicles.

### SUMMARY

In a feature, a battery includes: a positive output terminal; a negative output terminal; a first battery module that is connected to the positive output terminal and the negative output terminal and that includes: a first string of first and second types of battery cells that are electrically connected in series, where the first type is different than the second type; and a second battery module that is electrically connected in parallel with the first battery module and that includes: a second string of the first and second types of battery cells that are electrically connected in series.

In further features: the first type of battery cells include a first nominal voltage; the second type of battery cells include a second nominal voltage; and the second nominal voltage is one of greater than and less than the first nominal voltage.

In further features: the first string includes a first number of the first type of battery cells and a second number of the second type of battery cells; the second string includes a third number of the first type of battery cells and a fourth number of the second type of battery cells; the first number is equal to the third number; and the second number is equal to the fourth number.

In further features, the first number is one of greater than and less than the second number.

In further features, the first number is equal to the second number.

In further features: the first string includes the first and second types of battery cells electrically connected in series in a predetermined order; and the second string includes the first and second types of battery cells electrically connected in series in the predetermined order.

In further features: the first type of battery cells include a first voltage profile; and the second type of battery cells include a second voltage profile; and the second voltage profile is different than the first voltage profile.

In further features: the first type of battery cells include lithium iron phosphate (LFP) battery cells; and the second type of battery cells includes nickel manganese cobalt (NMC) battery cells.

In further features, a battery system includes: the battery; and a state of charge (SOC) module configured to: determine a first SOC of a first one of the second type of battery cells; and determine a second SOC of a second one of the first type of battery cells based on the first SOC of the first one of the second type of battery cells.

In further features: the first type of battery cells include a first energy density and a first power density; the second type of battery cells include a second energy density and a second power density; the first energy density is less than the second energy density; and the first power density is greater than the second power density.

In further features: the first type of battery cells include liquid battery cells; and the second type of battery cells include solid state battery cells.

In further features: the first type of battery cells include a first likelihood of causing a failure of a neighboring one of the second type of battery cells; the second type of battery cells include a second likelihood of causing a failure of a neighboring one of the first type of battery cells; and the first likelihood is greater than the second likelihood.

In further features: the first type of battery cells include liquid battery cells; and the second type of battery cells include solid state battery cells.

In further features: the first type of battery cells include lithium iron phosphate (LFP) battery cells; and the second type of battery cells includes nickel manganese cobalt (NMC) battery cells.

In further features, the first type of battery cells include nickel manganese cobalt (NMC) battery cells.

In further features, the first type of battery cells include lithium iron phosphate (LFP) battery cells.

In further features, the first type of battery cells include lithium sulfur battery cells.

In further features, the first type of battery cells include lithium iron manganese phosphate battery cells.

In further features, the first type of battery cells include one of nickel zinc cells and lithium cobalt (LCO) cells.

In further features, the first type of battery cells include at least one of: nickel cobalt aluminum (NCA) cathodes; and lithium titanate (LTO) anodes.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example engine control system;

FIG. 2 is a functional block diagram an example battery system of a vehicle; and

FIGS. 3-6 include functional block diagrams of example battery systems.

In the drawings, reference numbers may be reused to identify similar and/or identical elements.

### DETAILED DESCRIPTION

A battery may include a plurality of battery modules electrically connected in parallel. Each battery module includes a plurality of battery cells electrically connected in series. Examples of the battery cells include pouch battery cells, prismatic battery cells, or a combination of pouch and prismatic battery cells. Prismatic battery cells may be cylindrical or have another suitable shape.

Each battery module could include all of the same battery cells. The present application involves a battery (or battery pack) with multiple battery modules where each battery module includes two or more different types of battery cells. For example, each battery module may include two or more different nominal voltages to tune the voltage of each of the battery modules. As another example, each battery module may include two or more different types of battery cells that have different degrees of difficulty regarding state of charge (SOC) detection. The SOCs of battery cells that are easier to detect can be used to determine the SOCs of battery cells that are harder to detect since current to/from each of the battery cells of a battery module is equal. As another example, each battery module may include one or more battery cells having a higher power density and a lower energy density and one or more battery cells having a lower power density and a higher energy density. This may improve energy density but retain high power characteristics. As another example, each battery module may include one or more battery cells having a higher runaway temperature upon failure and one or more battery cells having a lower runaway temperature upon failure. This may improve thermal stability of the battery and minimize propagation upon failure of one or more battery cells. Each module including a combination of two or more different types of battery cells provides an improved battery.

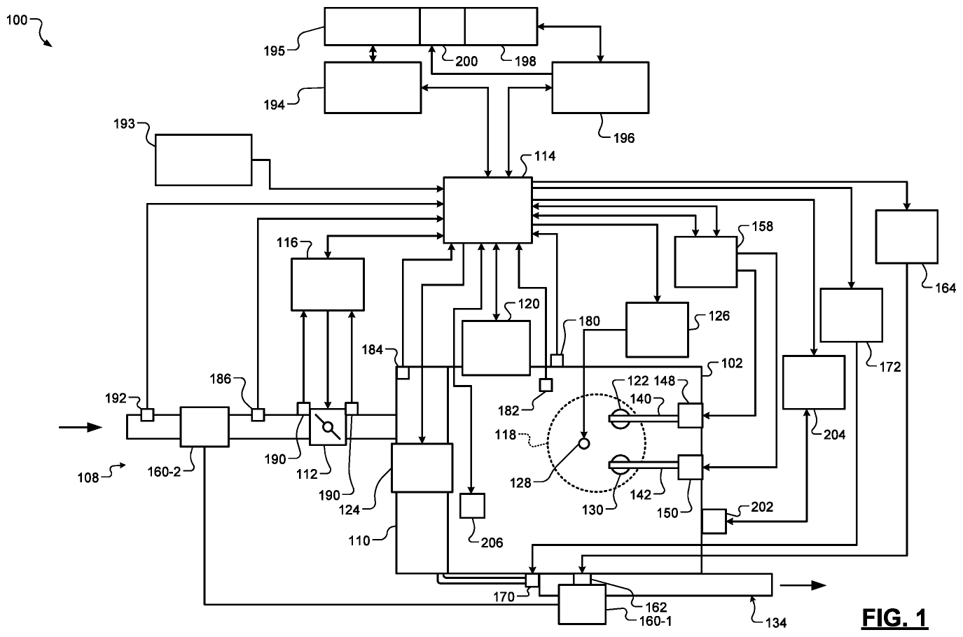

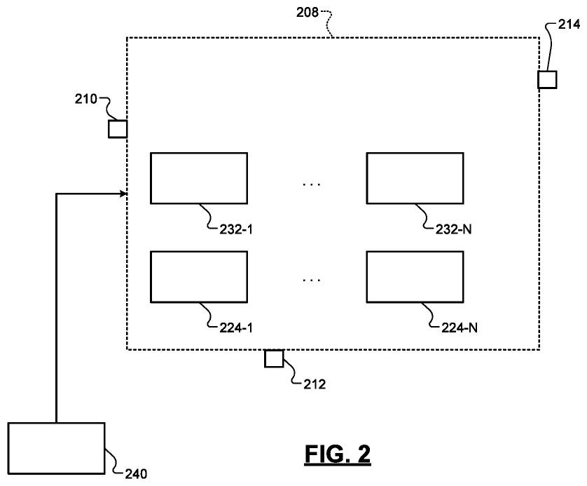

Referring now to FIG. 1, a functional block diagram of an example powertrain system 100 is presented for a hybrid vehicle. While the example of a hybrid vehicle is provided, the present application is applicable to non-vehicle applications that include a battery and other types of vehicles (e.g., electric, internal combustion engine, etc.).

The powertrain system 100 of a vehicle includes an engine 102 that combusts an air/fuel mixture to produce torque. The vehicle may be non-autonomous or autonomous. Air is drawn into the engine 102 through an intake system 108. The intake system 108 may include an intake manifold 110 and a throttle valve 112. For example only, the throttle valve 112 may include a butterfly valve having a rotatable blade. An engine control module (ECM) 114 controls a throttle actuator module 116, and the throttle actuator module 116 regulates opening of the throttle valve 112 to control airflow into the intake manifold 110.

Air from the intake manifold 110 is drawn into cylinders of the engine 102. While the engine 102 includes multiple cylinders, for illustration purposes a single representative cylinder 118 is shown. For example only, the engine 102 may include 2, 3, 4, 5, 6, 8, 10, and/or 12 cylinders. The ECM 114 may instruct a cylinder actuator module 120 to selectively deactivate some of the cylinders under some circumstances, which may improve fuel efficiency.

The engine 102 may operate using a four-stroke cycle or another suitable engine cycle. The four strokes of a four-stroke cycle, described below, will be referred to as the intake stroke, the compression stroke, the combustion stroke, and the exhaust stroke. During each revolution of a crankshaft (not shown), two of the four strokes occur within the cylinder 118. Therefore, two crankshaft revolutions are necessary for the cylinder 118 to experience all four of the strokes. For four-stroke engines, one engine cycle may correspond to two crankshaft revolutions.

When the cylinder 118 is activated, air from the intake manifold 110 is drawn into the cylinder 118 through an intake valve 122 during the intake stroke. The ECM 114 controls a fuel actuator module 124, which regulates fuel injection to achieve a desired air/fuel ratio. Fuel may be injected into the intake manifold 110 at a central location or at multiple locations, such as near the intake valve 122 of each of the cylinders. In various implementations (not shown), fuel may be injected directly into the cylinders or into mixing chambers/ports associated with the cylinders. The fuel actuator module 124 may halt injection of fuel to cylinders that are deactivated.

The injected fuel mixes with air and creates an air/fuel mixture in the cylinder 118. During the compression stroke, a piston (not shown) within the cylinder 118 compresses the air/fuel mixture. The engine 102 may be a compression-ignition engine, in which case compression causes ignition of the air/fuel mixture. Alternatively, the engine 102 may be a spark-ignition engine, in which case a spark actuator module 126 energizes a spark plug 128 in the cylinder 118 based on a signal from the ECM 114, which ignites the air/fuel mixture. Some types of engines, such as homogenous charge compression ignition (HCCI) engines may perform both compression ignition and spark ignition. The timing of the spark may be specified relative to the time when the piston is at its topmost position, which will be referred to as top dead center (TDC).

The spark actuator module 126 may be controlled by a timing signal specifying how far before or after TDC to generate the spark. Because piston position is directly related to crankshaft rotation, operation of the spark actuator module 126 may be synchronized with the position of the crankshaft. The spark actuator module 126 may disable provision of spark to deactivated cylinders or provide spark to deactivated cylinders.

During the combustion stroke, the combustion of the air/fuel mixture drives the piston down, thereby driving the crankshaft. The combustion stroke may be defined as the time between the piston reaching TDC and the time when the piston returns to a bottom most position, which will be referred to as bottom dead center (BDC).

During the exhaust stroke, the piston begins moving up from BDC and expels the byproducts of combustion through an exhaust valve 130. The byproducts of combustion are exhausted from the vehicle via an exhaust system 134.

The intake valve 122 may be controlled by an intake camshaft 140, while the exhaust valve 130 may be controlled by an exhaust camshaft 142. In various implementations, multiple intake camshafts (including the intake camshaft 140) may control multiple intake valves (including the intake valve 122) for the cylinder 118 and/or may control the intake valves (including the intake valve 122) of multiple banks of cylinders (including the cylinder 118). Similarly, multiple exhaust camshafts (including the exhaust camshaft 142) may control multiple exhaust valves for the cylinder 118 and/or may control exhaust valves (including the exhaust valve 130) for multiple banks of cylinders (including the cylinder 118). While camshaft-based valve actuation is shown and has been discussed, camless valve actuators may be implemented. While separate intake and exhaust camshafts are shown, one camshaft having lobes for both the intake and exhaust valves may be used.

The cylinder actuator module 120 may deactivate the cylinder 118 by disabling opening of the intake valve 122 and/or the exhaust valve 130. The time when the intake valve 122 is opened may be varied with respect to piston TDC by an intake cam phaser 148. The time when the exhaust valve 130 is opened may be varied with respect to piston TDC by an exhaust cam phaser 150. A phaser actuator module 158 may control the intake cam phaser 148 and the exhaust cam phaser 150 based on signals from the ECM 114. In various implementations, cam phasing may be omitted. Variable valve lift (not shown) may also be controlled by the phaser actuator module 158. In various other implementations, the intake valve 122 and/or the exhaust valve 130 may be controlled by actuators other than a camshaft, such as electromechanical actuators, electrohydraulic actuators, electromagnetic actuators, etc.

The engine 102 may include zero, one, or more than one boost device that provides pressurized air to the intake manifold 110. For example, FIG. 1 shows a turbocharger including a turbocharger turbine 160-1 that is driven by exhaust gases flowing through the exhaust system 134. A supercharger is another type of boost device.

The turbocharger also includes a turbocharger compressor 160-2 that is driven by the turbocharger turbine 160-1 and that compresses air leading into the throttle valve 112. A wastegate (WG) 162 controls exhaust flow through and bypassing the turbocharger turbine 160-1. Wastegates can also be referred to as (turbocharger) turbine bypass valves. The wastegate 162 may allow exhaust to bypass the turbocharger turbine 160-1 to reduce intake air compression provided by the turbocharger. The ECM 114 may control the turbocharger via a wastegate actuator module 164. The wastegate actuator module 164 may modulate the boost of the turbocharger by controlling an opening of the wastegate 162.

A cooler (e.g., a charge air cooler or an intercooler) may dissipate some of the heat contained in the compressed air charge, which may be generated as the air is compressed. Although shown separated for purposes of illustration, the turbocharger turbine 160-1 and the turbocharger compressor 160-2 may be mechanically linked to each other, placing intake air in close proximity to hot exhaust. The compressed air charge may absorb heat from components of the exhaust system 134.

The engine 102 may include an exhaust gas recirculation (EGR) valve 170, which selectively redirects exhaust gas back to the intake manifold 110. The EGR valve 170 may receive exhaust gas from upstream of the turbocharger turbine 160-1 in the exhaust system 134. The EGR valve 170 may be controlled by an EGR actuator module 172.

Crankshaft position may be measured using a crankshaft position sensor 180. An engine speed may be determined based on the crankshaft position measured using the crankshaft position sensor 180. A temperature of engine coolant may be measured using an engine coolant temperature (ECT) sensor 182. The ECT sensor 182 may be located within the engine 102 or at other locations where the coolant is circulated, such as a radiator (not shown).

A pressure within the intake manifold 110 may be measured using a manifold absolute pressure (MAP) sensor 184. In various implementations, engine vacuum, which is the difference between ambient air pressure and the pressure within the intake manifold 110, may be measured. A mass flow rate of air flowing into the intake manifold 110 may be measured using a mass air flow (MAF) sensor 186. In various implementations, the MAF sensor 186 may be located in a housing that also includes the throttle valve 112.

Position of the throttle valve 112 may be measured using one or more throttle position sensors (TPS) 190. A temperature of air being drawn into the engine 102 may be measured using an intake air temperature (IAT) sensor 192. One or more other sensors 193 may also be implemented. The other sensors 193 include an accelerator pedal position (APP) sensor, a brake pedal position (BPP) sensor, may include a clutch pedal position (CPP) sensor (e.g., in the case of a manual transmission), and may include one or more other types of sensors. An APP sensor measures a position of an accelerator pedal within a passenger cabin of the vehicle. A BPP sensor measures a position of a brake pedal within a passenger cabin of the vehicle. A CPP sensor measures a position of a clutch pedal within the passenger cabin of the vehicle. The other sensors 193 may also include one or more acceleration sensors that measure longitudinal (e.g., fore/aft) acceleration of the vehicle and latitudinal acceleration of the vehicle. An accelerometer is an example type of acceleration sensor, although other types of acceleration sensors may be used. The ECM 114 may use signals from the sensors to make control decisions for the engine 102.

The ECM 114 may communicate with a transmission control module 194, for example, to coordinate engine operation with gear shifts in a transmission 195. The ECM 114 may communicate with a hybrid control module 196, for example, to coordinate operation of the engine 102 and an electric motor 198. While the example of one electric motor is provided, multiple electric motors may be implemented. The electric motor 198 may be a permanent magnet electric motor or another suitable type of electric motor that outputs voltage based on back electromagnetic force (EMF) when free spinning, such as a direct current (DC) electric motor or a synchronous electric motor. In various implementations, various functions of the ECM 114, the transmission control module 194, and the hybrid control module 196 may be integrated into one or more modules.

Each system that varies an engine parameter may be referred to as an engine actuator. Each engine actuator has an associated actuator value. For example, the throttle actuator module 116 may be referred to as an engine actuator, and the throttle opening area may be referred to as the actuator value. In the example of FIG. 1, the throttle actuator module 116 achieves the throttle opening area by adjusting an angle of the blade of the throttle valve 112.

The spark actuator module 126 may also be referred to as an engine actuator, while the corresponding actuator value may be the amount of spark advance relative to cylinder TDC. Other engine actuators may include the cylinder actuator module 120, the fuel actuator module 124, the phaser actuator module 158, the wastegate actuator module 164, and the EGR actuator module 172. For these engine actuators, the actuator values may correspond to a cylinder activation/deactivation sequence, fueling rate, intake and exhaust cam phaser angles, target wastegate opening, and EGR valve opening, respectively.

The ECM 114 may control the actuator values in order to cause the engine 102 to output torque based on a torque request. The ECM 114 may determine the torque request, for example, based on one or more driver inputs, such as an APP, a BPP, a CPP, and/or one or more other suitable driver inputs. The ECM 114 may determine the torque request, for example, using one or more functions or lookup tables that relate the driver input(s) to torque requests.

Under some circumstances, the hybrid control module 196 controls the electric motor 198 to output torque, for example, to supplement engine torque output. The hybrid control module 196 may also control the electric motor 198 to output torque for vehicle propulsion at times when the engine 102 is shut down.

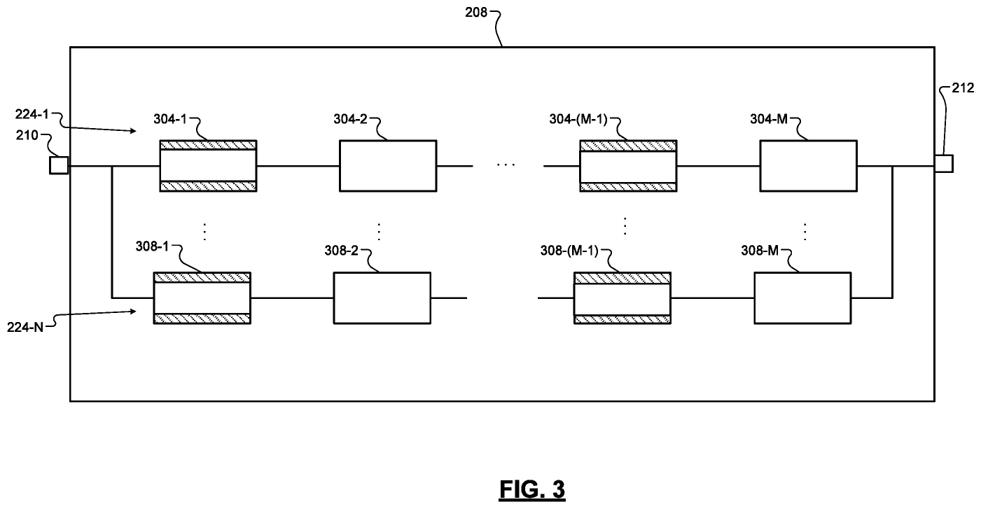

The hybrid control module 196 applies electrical power from a battery 208 (FIG. 2) to the electric motor 198 to cause the electric motor 198 to output positive torque. The battery is discussed further below. The electric motor 198 may output torque, for example, to an input shaft of the transmission 195, to an output shaft of the transmission 195, or to another component. A clutch 200 may be implemented to couple the electric motor 198 to the transmission 195 and to decouple the electric motor 198 from the transmission 195. One or more gearing devices may be implemented between an output of the electric motor 198 and an input of the transmission 195 to provide one or more predetermined gear ratios between rotation of the electric motor 198 and rotation of the input of the transmission 195. In various implementations, the electric motor 198 may be omitted. In vehicles, such as electric vehicles and autonomous vehicles, the battery 208 can be used to supply self redundant power to various systems, such as automotive safety integrity level (ASIL) systems, advanced driver assistant systems (ADAS), steer by wire systems, brake by wire systems, and other systems as well as serve multiple output voltages (e.g., 12 and 48 volts).

The ECM 114 starts the engine 102 via a starter motor 202. The ECM 114 or another suitable module of the vehicle engages the starter motor 202 with the engine 102 for an engine startup event. For example only, the ECM 114 may engage the starter motor 202 with the engine 102 when a key ON command is received. A driver may input a key ON command, for example, via actuating one or more ignition keys, buttons, and/or switches of the vehicle or of a key fob of the vehicle. The starter motor 202 may engage a flywheel coupled to the crankshaft or one or more other suitable components that drive rotation of the crankshaft.

The ECM 114 may also start the engine in response to an auto-start command during an auto-stop/start event or to an engine start command for a sailing event. Auto-stop/start events include shutting down the engine 102 while the vehicle is stopped, the driver has depressed the brake pedal, and the driver has not input a key OFF command. An auto-start command may be generated while the engine 102 is shut down for an auto-stop/start event, for example, when a driver releases the brake pedal and/or depresses the accelerator pedal. The driver may input a key OFF command, for example, via actuating the one or more ignition keys, buttons, and/or switches, as discussed above.

A starter motor actuator, such as a solenoid, may actuate the starter motor 202 into engagement with the engine 102. For example only, the starter motor actuator may engage a starter pinion with a flywheel coupled to the crankshaft. In various implementations, the starter pinion may be coupled to the starter motor 202 via a driveshaft and a one-way clutch. A starter actuator module 204 controls the starter motor actuator and the starter motor 202 based on signals from a starter control module, as discussed further below. In various implementations, the starter motor 202 may be maintained in engagement with the engine 102.

In response to a command to start the engine 102 (e.g., an auto-start command, an engine start command for an end of a sail event, or when a key ON command is received), the starter actuator module 204 supplies current to the starter motor 202 to start the engine 102. The starter actuator module 204 may also actuate the starter motor actuator to engage the starter motor 202 with the engine 102. The starter actuator module 204 may supply current to the starter motor 202 after engaging the starter motor 202 with the engine 102, for example, to allow for teeth meshing.

The application of current to the starter motor 202 drives rotation of the starter motor 202, and the starter motor 202 drives rotation of the crankshaft (e.g., via the flywheel). The period of the starter motor 202 driving the crankshaft to start the engine 102 may be referred to as engine cranking.

The starter motor 202 draws power from the battery 208 to start the engine 102. Once the engine 102 is running after the engine startup event, the starter motor 202 disengages or is disengaged from the engine 102, and current flow to the starter motor 202 may be discontinued. The engine 102 may be considered running, for example, when an engine speed exceeds a predetermined speed, such as a predetermined idle speed. For example only, the predetermined idle speed may be approximately 700 revolutions per minute (rpm) or another suitable speed. Engine cranking may be said to be completed when the engine 102 is running.

A generator 206 converts mechanical energy of the engine 102 into alternating current (AC) power. For example, the generator 206 may be coupled to the crankshaft (e.g., via gears or a belt) and convert mechanical energy of the engine 102 into AC power by applying a load to the crankshaft. The generator 206 rectifies the AC power into DC power and stores the DC power in the battery 208. Alternatively, a rectifier that is external to the generator 206 may be implemented to convert the AC power into DC power. The generator 206 may be, for example, an alternator. In various implementations, such as in the case of a belt alternator starter (BAS), the starter motor 202 and the generator 206 may be implemented together. In various implementations, one or more direct current (DC) to DC converters may be implemented.

FIG. 2 is a functional block diagram of an example battery system of the vehicle. The battery 208 has a positive output terminal and a negative terminal. In various implementations, the battery 208 may have two or more positive output terminals to provide at least two direct current (DC) operating voltages. For example only, the battery 208 may have a first positive (e.g., 48 Volt (V) nominal) terminal 210, a negative terminal 212, and a second positive (e.g., 12 V nominal) terminal 214. While the example of the battery 208 having a 48 V nominal operating voltage and a 12 V nominal operating voltage is provided, the battery 208 may have one or more other operating voltages.

The battery 208 may include a plurality of battery modules, such as a first battery module 224-1, . . . , and an N-th battery module 224-N (“battery modules 224”), where N is an integer greater than or equal to 2. In various implementations, N may be equal to 2, 3, 4, 5, 6, 8, 10, 12, or another suitable number. The battery modules 224 are electrically connected with each other in parallel.

As discussed further below, each of the battery modules 224 includes multiple battery strings. Each battery string may be individually replaceable. Each battery module may also be individually replaceable. The ability to individually replace the battery strings and/or modules may enable the battery 208 to include a shorter warranty period and have a lower warranty cost. The battery strings and modules may be individually isolatable, for example, in the event of a fault in a battery string. In various implementations, the battery 208 may have the form factor of a standard automotive grade 12 V battery. As discussed further below, each of the battery strings includes battery cells having different characteristics connected in series.

The battery 208 may include a plurality of switches, such as first switches 232-1, . . . , N-th switches 232-N (collectively “switches 232”). The switches 232 may enable the battery strings of the battery modules 224 to be connected in series, parallel, or combinations of series and parallel to provide target output voltages and capacities at the output terminals. A switch control module 240 controls the switches 232.

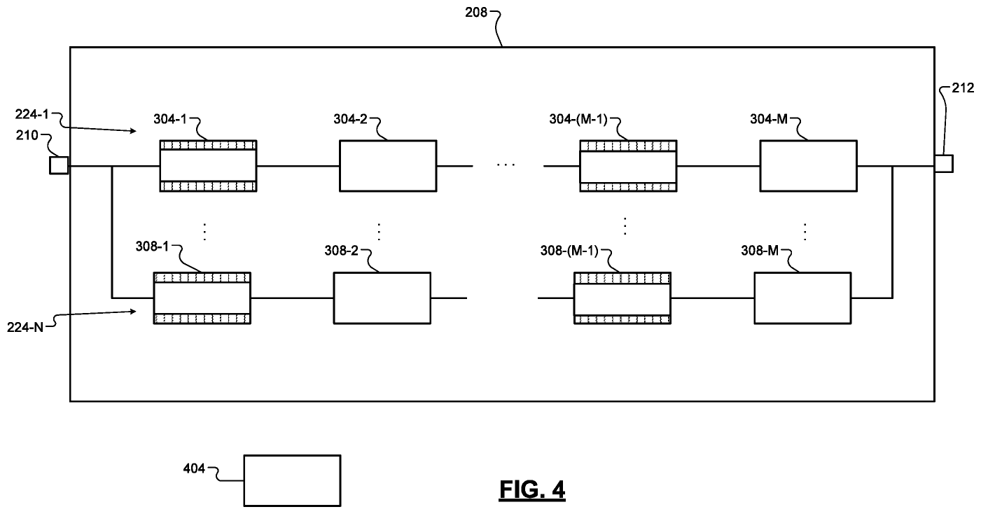

FIG. 3 is a functional block diagram of an example implementation of the battery 208. The battery 208 includes multiple battery modules 224 that are electrically connected in parallel and to output terminals, such as 210 and 212. Each of the battery modules 224 includes a string of battery cells that are electrically connected in series. For example, the battery module 224-1 includes battery cells 304-1, 304-2, 304 . . . . M where M is an integer greater than or equal to 4. The battery module 224-1 includes battery cells 308-1, 308-2, 304 . . . . M where M is an integer greater than or equal to 4.

Each of the battery strings includes battery cells having two or more different characteristics. For example, in the example of FIG. 3, each battery string includes first battery cells (battery cell A) having a first nominal voltage, such as 304-1, 304-(M−1), 308-1, and 308-(M−1) and second battery cells (battery cell B), such as 304-2, 304-M, 308-2, and 308-M having a second nominal voltage. The second nominal voltage is one of greater than and less than the first nominal voltage. Each battery string may have the same number of the first battery cells and the same number of the second battery cells. Each battery string has the first and second battery cells connected in series in the same order. While the example of alternating first battery cell, second battery cell, first battery cell, etc. is shown, the present application is also applicable to other orders. Also, while the example of first and second battery cells is provided, the present application is also applicable to the inclusion of one or more other battery cells having other suitable nominal voltages, such as third battery cells including a third nominal voltage that is different than the first and second nominal voltages, fourth battery cells including a fourth nominal voltage that is different than the first, second, and third nominal voltages, etc.

In the example of FIG. 3, the battery 208 would have a tunable voltage and tunable maximum (fully charged) defined by

$$x * V 1 + ( y - x ) * V 2 ,$$

where x is the number of first battery cells included per battery string, V1 is the first nominal voltage of the first battery cells, y is the number of second battery cells included per battery string, and V2 is the second nominal voltage of the second battery cells. x and y may be selected to provide (tune to) a predetermined nominal voltage for the battery 208.

In the example of FIG. 3, the first and second battery cells may be, for example, nickel manganese cobalt (NMC) cells, lithium iron phosphate (LFP) cells, lithium manganese iron phosphate (LMFP) cells, nickel zinc cells, lithium cobalt (LCO) cells, lithium sulfur cells, and/or one or more other suitable types of cells. In various implementations, the first and/or second cells may include nickel cobalt aluminum (NCA) cathodes and/or lithium titanate (LTO) anodes or other suitable cathode and/or anode chemistries.

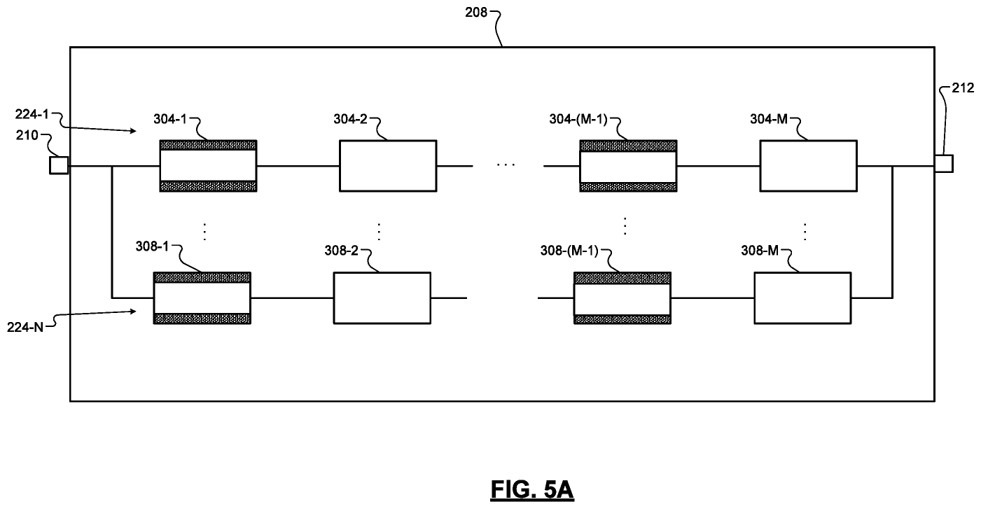

FIG. 4 is a functional block diagram of an example implementation of the battery 208. An SOC module 404 determines the SOC of each of the battery cells of each of the battery modules 224. The SOC module 404 may determine the SOC of a battery cell, for example, based on the voltage across that battery cell and coulomb counting. The voltage across each battery cell may be measured by respective voltage sensors. Since the battery cells of a string are connected in series, the coulomb count applies to all of the battery cells of a string.

In the example of FIG. 4, the first battery cells may be of a type that it is harder (and/or more inaccurate) for the SOC module 404 to determine the respective SOCs than the second battery cells, such as to having a flatter voltage profile and/or larger hysteresis characteristics. The second battery cells may be of a type that it is easier (and/or more accurate) for the SOC module 404 to determine the respective SOCs than the first battery cells. The first battery cells may be, for example, LFP cells, LMFP cells, or another suitable type of battery cell. The second battery cells may be, for example, NMC cells or another suitable type of battery cell.

The SOC module 404 may determine the SOCs of the second battery cells based on the SOCs of the first battery cells. For example, the SOC module 404 may set the SOCs of the second battery cells to ones (e.g., adjacent) of the SOCs of the first battery cells when the capacities of the first battery cells are the same as the capacities of the second battery cells. If the capacities of the first battery cells are different than the capacities of the second battery cells, the SOC module 404 may set the SOCs of the second battery cells based on ones (e.g., adjacent) of the SOCs of the first battery cells using an equation or a lookup table that relates the SOC of a first battery cell to the SOC of a second battery cell.

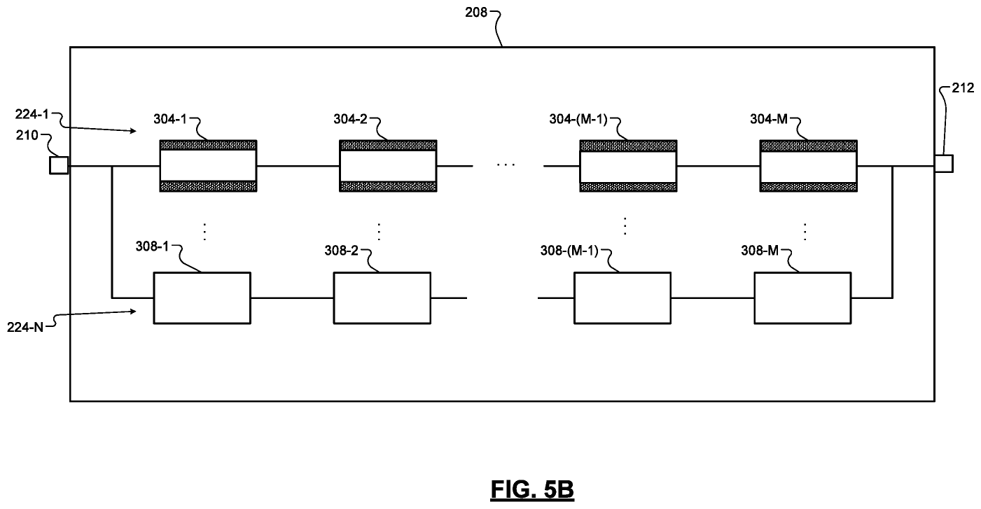

FIGS. 5A and 5B re a functional block diagram of an example implementation of the battery 208. In the example of FIGS. 5A and 5B, the first battery cells have a first (lower) energy density and a first (higher) power density, and the second battery cells have a second (higher) energy density and a second (lower) power density. The first energy density is less than the second energy density, and the first power density is greater than the second power density. The first battery cells may be, for example, liquid including battery cells. The second battery cells may be, for example, solid state battery cells. The solid state (second) battery cells improve energy density of the battery 208, such as for normal operation of the battery 208. The liquid (first) battery cells provide higher charge/discharge power, such as when the battery 208 is cold.

As shown in the example of FIG. 5B, strings of the two different types of battery cells are connected in parallel where each string includes the same type of battery cell connected in series. Therefore current is able to better be distributed between parallel cells.

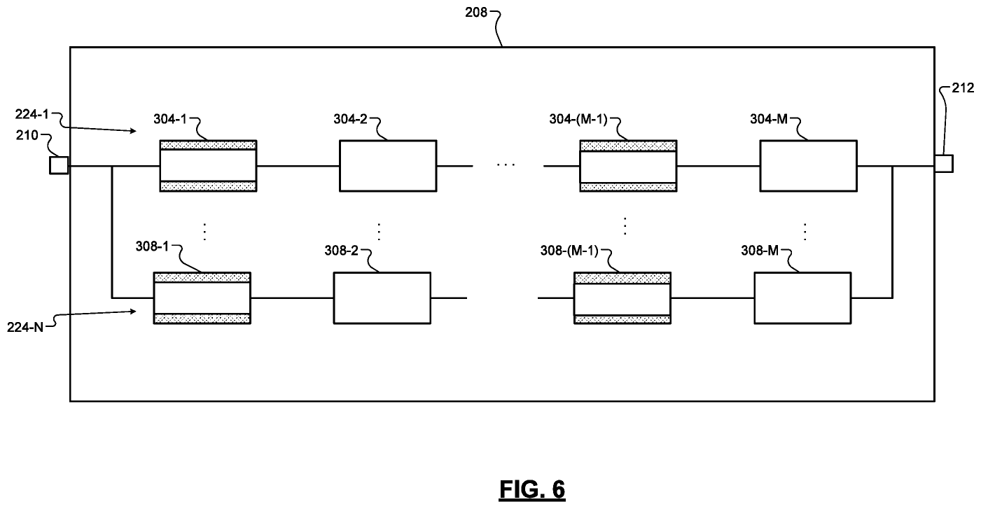

FIG. 6 is a functional block diagram of an example implementation of the battery 208. In the example of FIG. 6, the first battery cells have first thermal runaway characteristics (e.g., a first temperature when fail), and the second battery cells have second thermal runaway characteristics (e.g., a second temperature when fail). The second temperature may be less than the first temperature. The first battery cells may have a first (higher) energy density, and the second battery cells may have a second (lower) energy density. The first energy density may be greater than the second energy density. The first battery cells may be, for example, LFP cells or another suitable type of battery cell. The second battery cells may be, for example, NMC battery cells or another suitable type of battery cell. In various implementations, the first battery cells may be liquid battery cells and the second battery cells may be solid state battery cells. The first battery cells may have a higher likelihood of propagating a failure to a neighboring battery cell than the second battery cells.

With one or more of the second battery cells being disposed between adjacent first battery cells, a risk of a thermal runaway event may be decreased. For example, if one of the first battery cells suffers a failure and thermally runs away, propagation of the thermal runaway may be stopped by the neighboring second battery cells. As an example, if one of the second battery cells fails, because the neighboring first battery cells have the first (e.g., higher) temperature, the first battery cells may not fail, thereby preventing propagation of the failure past the one of the second battery cells.

While the examples of FIGS. 3-6 are illustrated separately, the features of one or more of FIGS. 3-6 may be combined.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A battery comprising:
a positive output terminal;
a negative output terminal;
a first battery module that is connected to the positive output terminal and the negative output terminal and that includes:
a first string of first and second types of battery cells that are electrically connected in series,
wherein the first type is different than the second type; and
a second battery module that is electrically connected in parallel with the first battery module and that includes:
a second string of the first and second types of battery cells that are electrically connected in series.

2. The battery of claim 1 wherein:
the first type of battery cells include a first nominal voltage;
the second type of battery cells include a second nominal voltage; and
the second nominal voltage is one of greater than and less than the first nominal voltage.

3. The battery of claim 1 wherein:
the first string includes a first number of the first type of battery cells and a second number of the second type of battery cells;
the second string includes a third number of the first type of battery cells and a fourth number of the second type of battery cells;
the first number is equal to the third number; and
the second number is equal to the fourth number.

4. The battery of claim 3 wherein the first number is one of greater than and less than the second number.

5. The battery of claim 3 wherein the first number is equal to the second number.

6. The battery of claim 1 wherein:
the first string includes the first and second types of battery cells electrically connected in series in a predetermined order; and
the second string includes the first and second types of battery cells electrically connected in series in the predetermined order.

7. The battery of claim 1 wherein:
the first type of battery cells include a first voltage profile; and
the second type of battery cells include a second voltage profile; and
the second voltage profile is different than the first voltage profile.

8. The battery of claim 7 wherein:
the first type of battery cells include lithium iron phosphate (LFP) battery cells; and
the second type of battery cells includes nickel manganese cobalt (NMC) battery cells.

9. A battery system comprising:
the battery of claim 8; and
a state of charge (SOC) module configured to:
determine a first SOC of a first one of the second type of battery cells; and
determine a second SOC of a second one of the first type of battery cells based on the first SOC of the first one of the second type of battery cells.

10. The battery of claim 1 wherein:
the first type of battery cells include a first energy density and a first power density;
the second type of battery cells include a second energy density and a second power density;
the first energy density is less than the second energy density; and
the first power density is greater than the second power density.

11. The battery of claim 10 wherein:
the first type of battery cells include liquid battery cells; and
the second type of battery cells include solid state battery cells.

12. The battery of claim 1 wherein:
the first type of battery cells include a first likelihood of causing a failure of a neighboring one of the second type of battery cells;
the second type of battery cells include a second likelihood of causing a failure of a neighboring one of the first type of battery cells; and
the first likelihood is greater than the second likelihood.

13. The battery of claim 12 wherein:
the first type of battery cells include liquid battery cells; and
the second type of battery cells include solid state battery cells.

14. The battery of claim 12 wherein:
the first type of battery cells include lithium iron phosphate (LFP) battery cells; and
the second type of battery cells includes nickel manganese cobalt (NMC) battery cells.

15. The battery of claim 1 wherein the first type of battery cells include nickel manganese cobalt (NMC) battery cells.

16. The battery of claim 1 wherein the first type of battery cells include lithium iron phosphate (LFP) battery cells.

17. The battery of claim 1 wherein the first type of battery cells include lithium sulfur battery cells.

18. The battery of claim 1 wherein the first type of battery cells include lithium iron manganese phosphate battery cells.

19. The battery of claim 1 wherein the first type of battery cells include one of nickel zinc cells and lithium cobalt (LCO) cells.

20. A vehicle comprising:
a battery comprising:
a positive output terminal;
a negative output terminal;
a first battery module that is connected to the positive output terminal and the negative output terminal and that includes:
a first string of first and second types of battery cells that are electrically connected in series,
wherein the first type is different than the second type; and
a second battery module that is electrically connected in parallel with the first battery module and that includes:
a second string of the first and second types of battery cells that are electrically connected in series; and
a load connected to the positive output terminal and the negative output terminal.
